(19) United States
(12) Patent Application Publication
(10) Pub. No.: US 2026/0332323 A1
(43) Pub. Date: Oct. 22, 2026

(54) CODE BLOCK ADJUSTMENTS

(71) Applicant: QUALCOMM Incorporated, San Diego, CA (US)

(72) Inventors: Kirill IVANOV, La Jolla, CA (US); Wei YANG, San Diego, CA (US); Jing SUN, San Diego, CA (US); Yu ZHANG, San Diego, CA (US)

(21) Appl. No.: 19/183,708

(22) Filed: Apr. 18, 2025

(51) Int. Cl. H04L 5/00

(52) U.S. Cl. CPC H04L 5/0016

(57) ABSTRACT

This disclosure provides methods, components, devices and systems for code block adjustments. In one aspect, a network entity may dynamically adjust one or more encoding parameters of special code block parts based on transmission parameters of a transmission. In one aspect, a network entity may encode the special code block parts in a transmission according to encoding characteristics which are dynamically adjusted based on transmission parameters used to transmit a codeword. Such transmission parameters may include a transport block size, a bandwidth, a quantity of spatial layers for transmission, a modulation and coding scheme index of the non-special code blocks, a quantity of code blocks included in the transmission, a quantity of resources present in the transmission, or a combination thereof. In some aspects, the network entity may transmit control signaling to indicate that one or more special code block parts are present in a code block transmission.

### TECHNICAL FIELD

This disclosure relates generally to wireless communication, and more specifically to systems, devices, methods, and techniques associated with code block (CB) adjustments.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol. In some aspects, a wireless device may communicate using arrangements of codewords mapped to time-frequency resources.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving, via a set of multiple time-frequency resources using one or more spatial layers, a set of multiple code block (CB) parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated and decoding the one or more first CB parts of the codeword according to the first encoding characteristics and the one or more second CB parts of the codeword according to the second encoding characteristics, the first encoding characteristics based on one or more transmission parameters of the codeword.

A UE for wireless communications is described. The UE may include a processing system that includes processor circuitry and memory circuitry that stores code. The processing system may be configured to cause the UE to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated and decode the one or more first CB parts of the codeword according to the first encoding characteristics and the one or more second CB parts of the codeword according to the second encoding characteristics, the first encoding characteristics based on one or more transmission parameters of the codeword.

Another UE for wireless communications is described. The UE may include means for receiving, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated and means for decoding the one or more first CB parts of the codeword according to the first encoding characteristics and the one or more second CB parts of the codeword according to the second encoding characteristics, the first encoding characteristics based on one or more transmission parameters of the codeword.

A non-transitory computer-readable medium storing code for wireless communications is described. The code may include instructions executable by one or more processors to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated and decode the one or more first CB parts of the codeword according to the first encoding characteristics and the one or more second CB parts of the codeword according to the second encoding characteristics, the first encoding characteristics based on one or more transmission parameters of the codeword.

In some aspects of the method, UEs, and non-transitory computer-readable medium described herein, the one or more transmission parameters include a transport block (TB) size of a TB associated with the codeword, a bandwidth of the set of multiple time-frequency resources, a quantity of the one or more spatial layers, a modulation and coding scheme (MCS) index associated with the one or more second CB parts, a quantity of CBs included in the codeword, a quantity of the set of multiple time-frequency resources, or a combination thereof.

In some aspects of the method, UEs, and non-transitory computer-readable medium described herein, the first encoding characteristics associated with the one or more first CB parts include a MCS, a shaping rate associated with probabilistic shaping of one or more bits of the one or more first CB parts, a modulation order, a coding rate, a transmit power, or a combination thereof.

In some aspects of the method, UEs, and non-transitory computer-readable medium described herein, at least one of the first encoding characteristics may be based on at least a first transmission parameter of the one or more transmission parameters satisfying one or more threshold values.

A method for wireless communications by a UE is described. The method may include receiving, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value and decoding the set of multiple CB parts according to first encoding characteristics, the first encoding characteristics based on the offset value, by which the second MCS index is negatively offset, being greater than the first MCS index.

A UE for wireless communications is described. The UE may include a processing system that includes processor circuitry and memory circuitry that stores code. The processing system may be configured to cause the UE to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value and decode the set of multiple CB parts according to first encoding characteristics, the first encoding characteristics based on the offset value, by which the second MCS index is negatively offset, being greater than the first MCS index.

Another UE for wireless communications is described. The UE may include means for receiving, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value and means for decoding the set of multiple CB parts according to first encoding characteristics, the first encoding characteristics based on the offset value, by which the second MCS index is negatively offset, being greater than the first MCS index.

A non-transitory computer-readable medium storing code for wireless communications is described. The code may include instructions executable by one or more processors to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value and decode the set of multiple CB parts according to first encoding characteristics, the first encoding characteristics based on the offset value, by which the second MCS index is negatively offset, being greater than the first MCS index.

In some aspects of the method, UEs, and non-transitory computer-readable medium described herein, the decoding the set of multiple CB parts may include operations, features, means, or instructions for decoding the one or more first CB parts according to the first MCS index and the one or more second CB parts according to a lowest configured MCS index of a set of multiple MCS indices configured for the UE.

In some aspects of the method, UEs, and non-transitory computer-readable medium described herein, the decoding the one or more second CB parts may include operations, features, means, or instructions for decoding the one or more second CB parts according to a first coding rate that may be less than a second coding rate associated with the lowest configured MCS index.

In some aspects of the method, UEs, and non-transitory computer-readable medium described herein, the receiving the set of multiple CB parts may include operations, features, means, or instructions for receiving the one or more first CB parts without the one or more second CB parts.

In some aspects of the method, UEs, and non-transitory computer-readable medium described herein, the receiving the set of multiple CB parts may include operations, features, means, or instructions for receiving data via the one or more first CB parts and one or more reference signals via the one or more second CB parts.

A method for wireless communications by a UE is described. The method may include receiving, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated, receiving control signaling indicating a presence of the one or more first CB parts in the TB that are the initializing CB parts associated with the first encoding characteristics, and decoding, based on the control signaling, the one or more first CB parts according to the first encoding characteristics and the one or more second CB parts according to the second encoding characteristics.

A UE for wireless communications is described. The UE may include a processing system that includes processor circuitry and memory circuitry that stores code. The processing system may be configured to cause the UE to receive, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated, receive control signaling indicating a presence of the one or more first CB parts in the TB that are the initializing CB parts associated with the first encoding characteristics, and decode, based on the control signaling, the one or more first CB parts according to the first encoding characteristics and the one or more second CB parts according to the second encoding characteristics.

Another UE for wireless communications is described. The UE may include means for receiving, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated, means for receiving control signaling indicating a presence of the one or more first CB parts in the TB that are the initializing CB parts associated with the first encoding characteristics, and means for decoding, based on the control signaling, the one or more first CB parts according to the first encoding characteristics and the one or more second CB parts according to the second encoding characteristics.

A non-transitory computer-readable medium storing code for wireless communications is described. The code may include instructions executable by one or more processors to receive, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated, receive control signaling indicating a presence of the one or more first CB parts in the TB that are the initializing CB parts associated with the first encoding characteristics, and decode, based on the control signaling, the one or more first CB parts according to the first encoding characteristics and the one or more second CB parts according to the second encoding characteristics.

In some aspects of the method, UEs, and non-transitory computer-readable medium described herein, the one or more first CB parts include control information and the one or more second CB parts include data.

In some aspects of the method, UEs, and non-transitory computer-readable medium described herein, the control signaling indicates a quantity of the one or more first CB parts present within the TB.

### BRIEF DESCRIPTION OF THE DRAWINGS

FIG. 1 shows an example of a wireless communication system.

FIG. 2 shows an example of a mapping scheme that supports code block (CB) adjustments.

FIG. 3 shows an example of a mapping scheme that supports CB adjustments.

FIG. 4 shows an example of a process flow that supports CB adjustments.

FIG. 5 shows a block diagram of a processing system that supports CB adjustments.

FIG. 6 shows a diagram of a system including a device that supports CB adjustments.

FIGS. 7 through 9 show flowcharts illustrating methods that support CB adjustments.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications, multiple spatial layers may be used to increase the capacity or enhance other characteristics of wireless transmissions. Such transmissions may be transmitted using codewords, which may be divided into code blocks (CBs) and CB parts belonging to the same CB that may be offset in time across a set of time-frequency resources or occupying the same time-frequency resources on different spatial layers. In one aspect, a first CB part may occupy a set of frequency resources in a first spatial layer and a second CB part belonging to the same CB or a different CB may occupy the set of frequency resources in a second spatial layer, such that pairs or other groups of CB parts may occupy the same frequency resources across the spatial layers. This may also allow for sequential interference cancelation (SIC) techniques to be employed, by canceling the effects of a first CB or CB part from a signal that also includes other CBs or CB parts.

Further, due to the offset structure, “heads” and “tails” of a group of CBs may include resources in which a special or a different CB or CB part may be transmitted. Such special or different CBs may be designed to be more easily decoded (e.g., due to one or more encoding characteristics) and may then be canceled from signals involving other CBs or CB parts. In some aspects, such special CB parts may have a lower modulation and coding scheme (MCS) than the other CB parts according to an offset value, which may be referred to as an MCS delta. In some cases, a relative impact (e.g., importance) of the special CB parts to improve a throughput of a transmission may vary based on characteristics of the transmission (e.g., quantity of CBs in the transmission, MCS of the other CB parts in the transmission), which may result in a waste of processing power in cases where the special CB parts may provide only a marginal benefit.

Aspects of the subject matter described in this disclosure relate to CB adjustments. In one aspect, a network entity may dynamically adjust one or more encoding parameters of special CB parts based on transmission parameters of a transmission that includes the special CB parts. In one aspect, a network entity may encode the special CB parts in a CB transmission according to encoding characteristics (e.g., an MCS, a delta MCS from the other CBs, a shaping rate, a modulation order, a coding rate, a transmit power) which are dynamically adjusted (e.g., on a per-transmission basis) based on transmission parameters used to transmit the CB transmission. Such transmission parameters may include a transport block (TB) size, a bandwidth, a quantity of spatial layers for transmission, an MCS index of the non-special CBs, a quantity of CBs included in the transmission, a quantity of available resources present in the transmission, or a combination thereof. In some aspects, an MCS delta for a special TB may be greater than an MCS index of the non-special CBs, and the network entity may encode the special CB according to encoding rules which are based on such a condition. In some aspects, the network entity may transmit control signaling to indicate that one or more special CB parts are present in a CB transmission (e.g., in a single-layer transmission).

Particular aspects of the subject matter described in this disclosure can be implemented to realize one or more of the following potential advantages. In some aspects, by dynamically adjusting encoding parameters of the special CB parts based on transmission parameters, the described techniques can be used to reduce processing power and reduce a decoding complexity associated with a communication of the special CB parts, which may promote energy savings at the UE. In one aspect, in transmissions that include a relatively high quantity of CBs or a relatively high MCS index of non-special CBs, increased power savings may be achieved by decreasing a complexity of the special CB part encoding, which may result in longer battery life of devices and increased spectral efficiency, among other benefits.

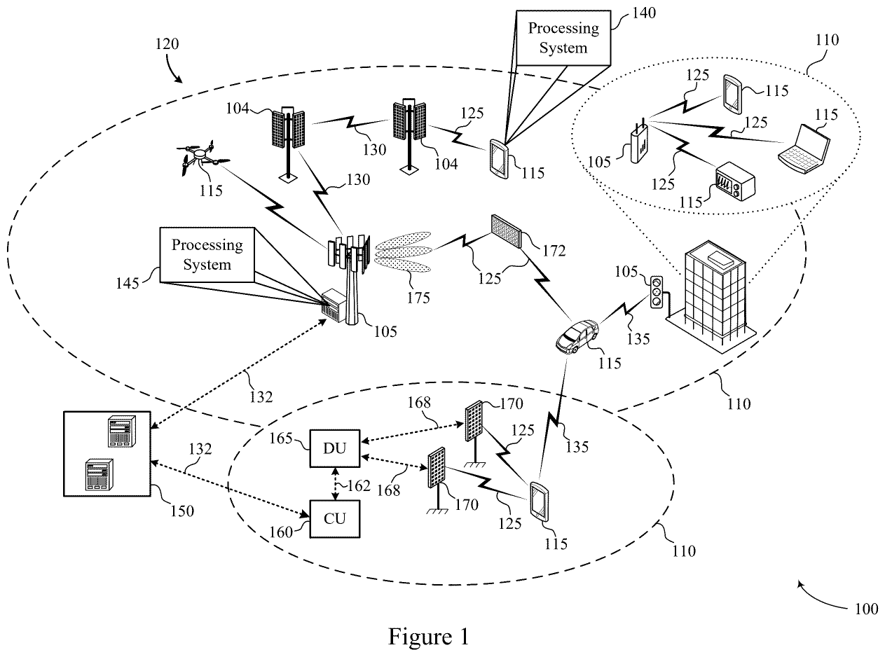

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. In one aspect, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some aspects, a network entity 105 may be implemented in an aggregated (such as monolithic, standalone) architecture, which may utilize a protocol stack that is physically or logically integrated within one network entity 105 (such as a single physical RAN node). In some other aspects, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. In one aspect, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. In one aspect, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. In one aspect, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. In one aspect, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. In one aspect, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for CB adjustments. In one aspect, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reduced processing power and reduced decoding complexity associated with a communication of special CB parts in a CB transmission, which may promote energy savings at the UE. In one aspect, in transmissions that include a relatively high quantity of CBs or a relatively high MCS index of non-special CBs, increased power savings may be achieved by decreasing a complexity of the special CB part encoding, which may result in longer battery life of devices and increased spectral efficiency, among other benefits.

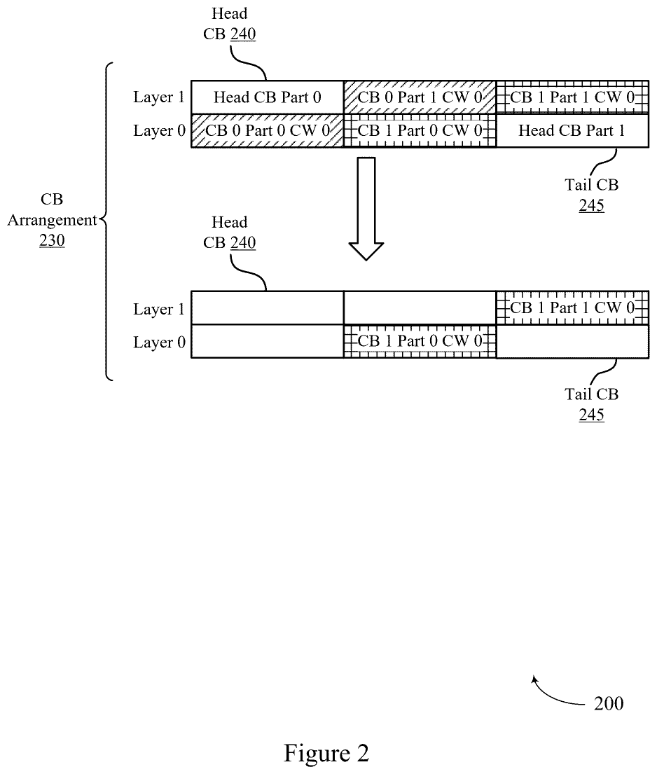

FIG. 2 shows an example of a mapping scheme 200 that supports CB adjustments. The mapping scheme 200 may include a CB arrangement 230 that may be used for transmission and reception (e.g., by a UE 115, by a network entity 105) of one or more codewords, where each codeword may include one or more CBs. In some aspects, a codeword may be considered to be equivalent to a TB in the context of the techniques described herein, although a TB may include multiple codewords, in some cases. Further, it should be understood that a CB may include multiple CB parts. As such, a codeword may include multiple CBs, and each CB may include multiple CB parts.

In some aspects, a dual-codeword MIMO design structure may be used, in which a first codeword (e.g., CW0) and a second codeword (e.g., CW1) may be assigned different rates. In some aspects, a hard SIC technique may be applied in association with decoding the CBs. Such an arrangement may achieve a MIMO capacity (e.g., in association with a linear minimum mean squared error (LMMSE) using an SIC receiver. However, in some aspects, use of the dual-codeword MIMO design structure may involve additional considerations, such as the use of an accurate per-codeword channel quality indicator (CQI) or separate outer-loops per codeword.

In some other aspects, a single-codeword design may be used which may involve, in one aspect, irregular low-density parity check (LDPC) codes. In some aspects, use of the single-codeword design may involve the use of a non-linear MIMO demodulation (e.g., per-stream recursive demapping (PSRD) or ePSRD) to obtain improved performance. Additionally, or alternatively, such techniques may involve the use of iterative demodulation or decoding across layers to achieve capacity. In some aspects, the use of LDPCs (e.g., LDPCs based on the use of additive white Gaussian noise (AWGN)) may not be ideal for iterative demodulation or decoding. As such, in some aspects, the use of the single-codeword design may be less desirable (e.g., compared to the dual-codeword MIMO design structure) in terms of performance.

The CB arrangement 230 may be a single codeword design that may include spatial coupling techniques (e.g., of a diagonal Bell Labs Layered Space-Time (D-BLAST) type or other spatial coupling techniques). In some aspects involving the CB arrangement 230, a single codeword rate may be selected to match a collective channel quality across multiple layers. In some aspects, a code structure similar to a D-BLAST structure may be employed (e.g., in which a single codeword captures relatively more channel realizations).

In some aspects, demapping operations may involve successive interference cancellation. In one aspect, CB0 may be demodulated and decoded first. If CB0 is successfully decoded, CB0 may be subtracted from the received signal, after which CB1 may be demodulated and decoded. If CB1 is successfully decoded, CB1 may be subtracted from the received signal. Such procedures may be repeated until all CBs are successfully decoded or CB decoding failure is declared. In some aspects, the use of the CB arrangement 230 may be referred to as spatial coupling (SC) MIMO (SC-MIMO).

In some aspects, however, the use of SC-MIMO may involve special or additional techniques for handling the head CB 240 (and tail CB 245) of the SC chain, in order for the successive cancellation to start. In some cases, the head CB 240 (and tail CB 245) may be left empty, or known information may be included in the head CB 240, to enable the start of SC decoding. However, such approaches may result in a rate loss, which may not be negligible. The head CB 240 and the tail CB 245 may be elsewhere referred to herein as special CB parts or initializing CB parts (e.g., special CB parts may include head CBs 240, tail CBs 245, or any combination thereof).

In some aspects, a wireless communication device (e.g., a UE, a network entity) may receive, via a set of time-frequency resources using multiple spatial layers, multiple CB parts associated with a codeword, where CB parts corresponding to the same CBs or different CBs are transmitted over the same time-frequency resources on different spatial layers. In some aspects, one or more first CB parts may be initializing CB parts associated with (e.g., encoded using) first encoding characteristics that are different than second encoding characteristics with which one or more second CB parts are associated. The wireless communication device may decode, based on the first encoding characteristic and the second encoding characteristics, the one or more first CB parts and the one or more second CB parts.

In some cases, a relative impact (e.g., importance) of the special CB parts to improve a throughput of a transmission may vary based on characteristics of the transmission. In cases where the second CB parts are encoded with relatively low MCS values (e.g., or when operating at lower signal-to-noise-ratio (SNR) values), the first CB parts (e.g., special CB parts) may have a relatively large impact in reducing throughput and performance losses. On the other hand, in cases where the second CB parts are encoded with relatively high MCS values (e.g., or when a relatively large quantity of CBs are encoded for the codeword), the second CB parts (e.g., special CB parts) may have relatively lower impact in reducing the throughput and performance losses.

In accordance with aspects described herein, the first encoding characteristics with which the first CB parts are encoded may be based on transmission parameters of the codeword (e.g., of a transmission that includes the codeword). In one aspect, a transmitting wireless communication device (e.g., a UE, a network entity) may dynamically modify encoding characteristics for encoding the special CB parts based on the transmission parameters. The encoding characteristics to be dynamically modified may include an MCS for encoding the special CB parts (e.g., or an MCS delta relative to the non-special CB parts), a shaping rate associated with probabilistic shaping of one or more bits of the special CB parts, a modulation order for encoding the special CB parts, a coding rate for encoding the special CB parts, a transmit power used to transmit the special CB parts, or a combination thereof.

The transmission parameters which are used to inform dynamic modification of the encoding characteristics may include a TB size of a TB associated with the codeword, a bandwidth of the time-frequency resources, a quantity of the one or more spatial layers, an MCS index associated with the second CB parts (e.g., non-special CB parts), a quantity of CBs included in the codeword, a quantity of the time-frequency resources (e.g., available for the transmission), or a combination thereof. In one aspect, any of the encoding characteristics (e.g., including combinations of the encoding characteristics) may be based on any one of the transmission parameters or a combination of multiple transmission parameters.

In some aspects, the MCS delta value, which may be a difference between a first MCS index for the second CB parts (e.g., non-special CB parts) and a first MCS index for the first CB parts (e.g., special CB parts), may be based on any one of the transmission parameters or a combination of multiple transmission parameters. In a first illustrative aspect, the MCS delta value may be based on a combination of the bandwidth of the time-frequency resources and the MCS index associated with the second CB parts. In one aspect, the MCS delta may be determined according to comparison of the MCS index with one or more thresholds, and the thresholds may be according to values of the bandwidth.

If the bandwidth is 100 Megahertz (MHz), then the MCS index may be compared with a first threshold (e.g., T₁₀₀) to determine the MCS delta value. If the MCS index is above the first threshold, then the MCS delta value for encoding the first CB parts is 0. If the MCS index is below the first threshold, then the MCS delta value for encoding the first CB parts is 3. If, the bandwidth is 20 MHz, then the MCS index may be compared with a second threshold (e.g., T₂₀) to determine the MCS delta value. If the MCS index is below the second threshold, then the MCS delta value for encoding the first CB parts is 0. If the MCS index is above the second threshold, then the MCS delta value for encoding the first CB parts is 3. It is to be understood that the combination of the bandwidth and the MCS index is exemplary, and any other combination of transmission parameters may also be used for determining the MCS index, or for determining any of the other encoding characteristics for the special CB parts described herein. In one aspect, the MCS delta value may be based on a combination of the quantity of spatial layers and the TB size or a combination of the quantity of spatial layers and the quantity of time-frequency resources.

In a second illustrative aspect, the MCS delta value may be based on the quantity of CBs included in the codeword. If the quantity of CBs (e.g., after TB segmentation) is greater than a threshold quantity of CBs, then the MCS delta value for encoding the first CB parts is 0. Otherwise, if the quantity of CBs is less than the threshold quantity of CBs, then the MCS delta value for encoding the first CB parts is 3.

In some aspects, any of the encoding characteristics described herein may be based on an output of a decreasing function of at least one of the transmission parameters (e.g., a first transmission parameter). The decreasing function may be a logarithmic function, an inverse function, or any other decreasing mathematical function. In Equation 1 below, the MCS delta value may be based on a decreasing function of the MCS index associated with the second CB parts (e.g., non-special CB parts).

$$delta\_MCS = \vert log \frac{30}{MCS} \vert \qquad ( 1 )$$

In one aspect, in Equation 1, the MCS index associated with the second CB parts is an input to the decreasing function, and the output is the MCS delta value. One or more relationships (e.g., associations) between the transmission parameters and the encoding characteristics, including the one or more threshold values, the decreasing functions, or otherwise, may be defined according to one or more rules or may be indicated via values in one or more look-up tables.

In some aspects, an MCS delta value for encoding the first CB parts (e.g., special CB parts) may be greater than the MCS index associated with the second CB parts. In such aspects, an encoding of the first CB parts may be according to one or more encoding rules that are based on the MCS delta value being greater than the MCS index (e.g., resulting in an MCS index for the first CB parts that is negative). The MCS delta value may be greater than the MCS index of the non-special CBs based on a dynamic determination of the MCS delta value based on transmission parameters according to techniques described herein. Additionally, or alternatively, the transmitting wireless device (e.g., network entity) may indicate that the first CB parts are encoded according to an MCS delta value that is greater than the MCS index of the non-special CBs.

In some aspects, based on the MCS delta value being greater than the MCS index, the first CB parts may be encoded according to an MCS index that is equal to a lowest MCS index (e.g., MCS 0) of a set of MCS indices configured for communication. Additionally, or alternatively, the first CB parts may be encoded using a coding rate that is less than the coding rate associated with the lowest MCS index (e.g., half the coding rate of MCS 0), which may lower the spectral efficiency to below a spectral efficiency of the lowest MCS index.

In some aspects based on the MCS delta value being greater than the MCS index, the transmitting wireless device may not transmit anything via the time-frequency resources associated with the first CB parts (e.g., set the special CB rate to 0). In one aspect, the transmitting wireless device may leave the time-frequency resources associated with the first CB parts empty. Alternatively, the transmitting wireless device may transmit a reference signal (e.g., or other pre-defined signal) via the time-frequency resources associated with the first CB parts. In one aspect, the transmitting wireless device may transmit one or more DMRSs (e.g., additional DMRSs) via the time-frequency resources associated with the first CB parts.

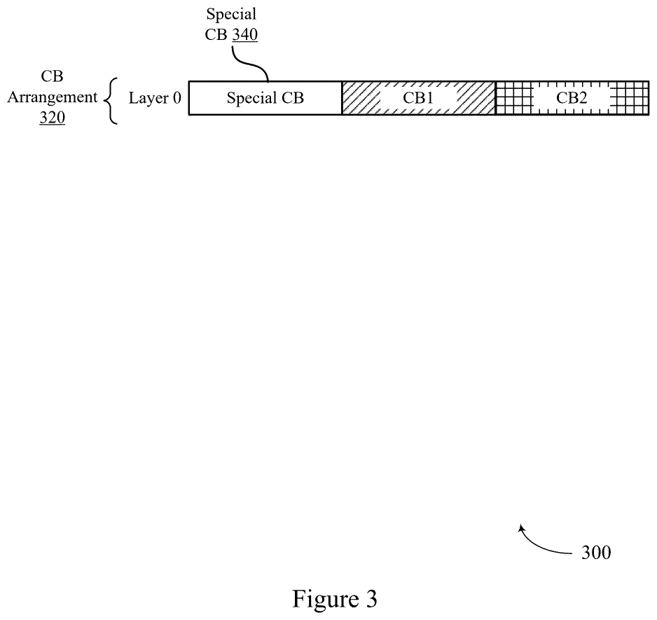

FIG. 3 shows an example of a mapping scheme 300 that supports CB adjustments. The mapping scheme 300 may include a CB arrangement 320 that may be used for transmission and reception (e.g., by a UE 115, by a network entity 105) of one or more codewords, where each codeword may include one or more CBs.

In some aspects, a wireless communication device (e.g., a UE, a network entity) may receive, via time-frequency resources using a single spatial layer (e.g., Layer 0), a TB that includes multiple CBs associated with a codeword, where the CBs in the TB are each offset in different time resources. In some aspects, one or more first CBs (e.g., special CB 340) in the TB may be initializing CBs (e.g., special CBs) which are associated with first encoding characteristics that are different than second encoding characteristics with which one or more second CBs (e.g., non-special CBs, CB1, CB2) are associated. The wireless communication device may decode, based on the first encoding characteristics and the second encoding characteristics, the first CBs and the second CBs of the TB.

In such aspects, the transmitter of the TB (e.g., the network entity) may transmit control signaling indicating that one or more of the CBs in the TB are the initializing CBs that have the first encoding characteristics (e.g., to promote a higher reliability of transmission). In one aspect, the transmitter may indicate a presence of the one or more first CBs that accompany the one or more second CBs in the TB. Additionally, or alternatively, the control signaling may indicate locations of the one or more first CBs within the TB, one or more encoding characteristics associated with the one or more first CBs, or a combination thereof.

In some aspects, the one or more first CBs may include control information (e.g., medium access control-control elements (MAC-CEs)) and the one or more second CBs may include data. By indicating that the one or more first CBs including the control information are encoded according to the first encoding characteristics (e.g., are special CBs), the transmitter of the TB may encode the initializing CBs with a relatively higher reliability in a same TB with the data. In one aspect, the control information and the data may be communicated via a same physical channel (e.g., a same TB), but the control information may be transmitted at a higher reliability relative to the data in accordance with encoding characteristics of the special CBs.

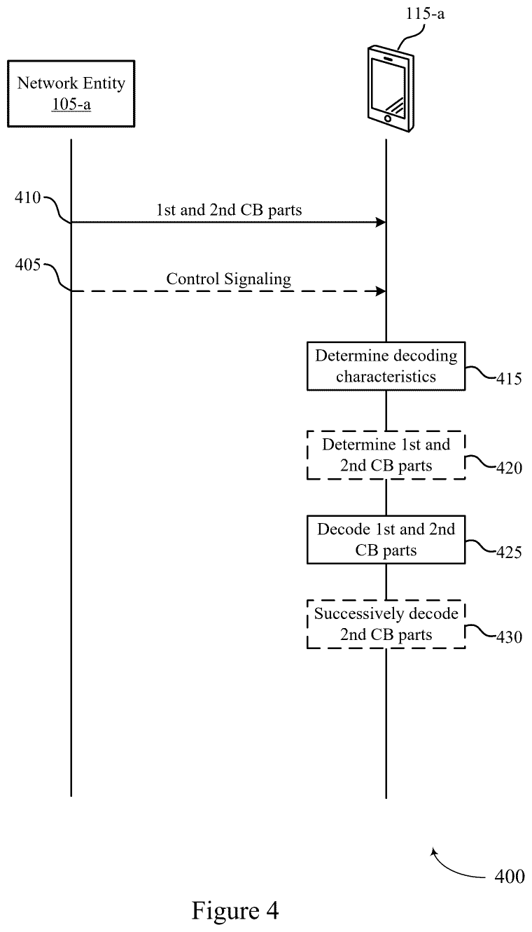

FIG. 4 shows an example of a process flow 400 that supports CB adjustments. The process flow 400 may implement or be implemented by aspects of the wireless communications system 100. In one aspect, the process flow 400 may include a UE 115-a and a network entity 105-a, which may be aspects of corresponding devices described herein. In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 405, the UE 115-a may receive, via a set of multiple time-frequency resources, a transmission (e.g., a TB) that includes multiple CB parts associated with a codeword. Respective CB parts of the multiple CB parts corresponding to the same CBs may be each offset in different time-frequency resources (e.g., offset in time across a set of time-frequency resources). One or more first CB parts of the multiple CB parts may be initializing CB parts (e.g., special CB parts) associated with first encoding characteristics. One or more second CB parts (e.g., non-special CB parts) of the multiple CB parts may be associated with second encoding characteristics different from the first encoding characteristics. The UE 115-a may receive the multiple CB parts using a single spatial layer or using multiple spatial layers.

In accordance with aspects described herein, the first encoding characteristics may be based on one or more transmission parameters of the transmission of the codeword. In one aspect, the first transmission parameters may be based on a TB size of a TB associated with the codeword, a bandwidth of the set of multiple time-frequency resources, a quantity of spatial layers associated with the transmission, an MCS index associated with the one or more second CB parts, a quantity of CBs included in the codeword, a quantity of the set of multiple time-frequency resources, or a combination thereof. The first encoding characteristics, which are modified dynamically based on the transmission parameters of the codeword, may include a MCS, a shaping rate associated with probabilistic shaping of one or more bits of the one or more first CB parts, a modulation order, a coding rate, a transmit power, or a combination thereof.

At 410, the UE 115-a may receive control signaling indicating a presence of the one or more first CB parts in the codeword that are the initializing CB parts (e.g., special CB parts) associated with the first encoding characteristics. Additionally, or alternatively, the control signaling may indicate the first encoding characteristics (e.g., including the MCS delta relative to the non-special CB parts). In some aspects, the control signaling may indicate the presence of one or multiple initializing CBs (e.g., special CBs) in a single layer transmission that includes at least one other CB (e.g., non-special CB).

At 415, the UE 115-a may determine the first encoding characteristics based on the transmission parameters of the codeword. In one aspect, the UE 115-a may determine whether the transmission parameters (e.g., at least a first transmission parameter) satisfy one more thresholds (e.g., fall within one or more ranges) and may determine the first encoding characteristics based on the transmission parameters satisfying the one or more thresholds. The thresholds for comparison may be based on second transmission parameters different from the transmission parameters. Additionally, or alternatively, the UE 115-a may apply a decreasing function to one or more of the transmission parameters and determine the encoding characteristics based on an output of the decreasing function.

At 420, the UE 115-a may determine the one or more first CB parts based on the determination of the first encoding characteristics. At 425, the UE 115-a may decode, based on the first encoding characteristics and the second encoding characteristics, the one or more first CB parts and the one or more second CB parts.

At 430, the UE 115-a may decode, successively and based on the second encoding characteristics, the one or more second CB parts associated with corresponding second time-frequency resources of the set of multiple time-frequency resources based on cancellation of the decoded one or more first CB parts or decoded second CB parts from one or more respective signals associated with the one or more second CB parts and received during corresponding second time-frequency resources of the plurality of time-frequency resources. In some aspects, to decode the one or more second CB parts, the UE 115-a may decode respective first groups of second CB parts based on cancellation of respective second groups of second CB parts.

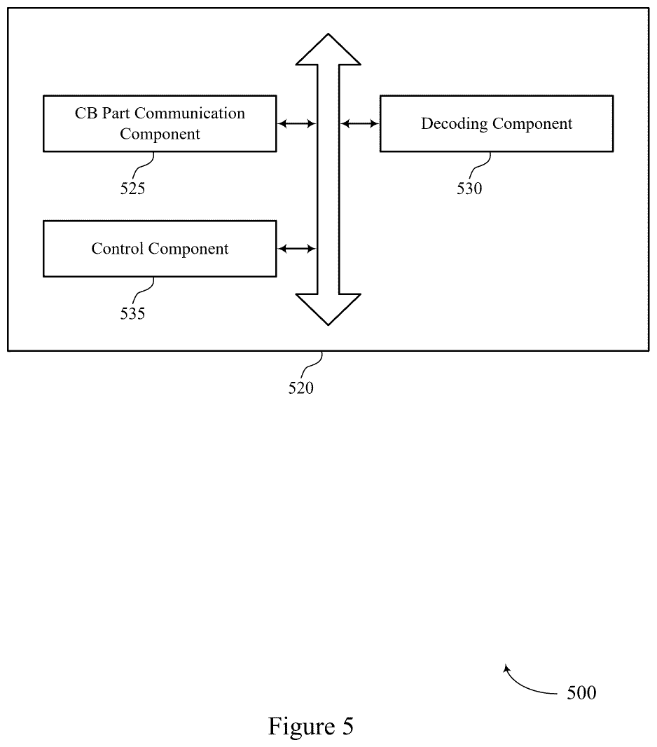

FIG. 5 shows an example 500 of a processing system 520 that supports CB adjustments. A processing system 520 may be an example of a processing system 140 (such as of a UE 115) and may include a CB part communication component 525, a decoding component 530, a control component 535, or any combination thereof. A processing system 520, or various component thereof, may be an example of means for performing (such as a means for causing a UE 115 to perform) various techniques described herein.

The CB part communication component 525 may be configured to cause the UE 115 to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated. The decoding component 530 may be configured to cause the UE 115 to decode the one or more first CB parts of the codeword according to the first encoding characteristics and the one or more second CB parts of the codeword according to the second encoding characteristics, the first encoding characteristics based on one or more transmission parameters of the codeword.

In some aspects, the one or more transmission parameters include a TB size of a TB associated with the codeword, a bandwidth of the set of multiple time-frequency resources, a quantity of the one or more spatial layers, a MCS index associated with the one or more second CB parts, a quantity of CBs included in the codeword, a quantity of the set of multiple time-frequency resources, or a combination thereof.

In some aspects, the first encoding characteristics associated with the one or more first CB parts include a MCS, a shaping rate associated with probabilistic shaping of one or more bits of the one or more first CB parts, a modulation order, a coding rate, a transmit power, or a combination thereof.

In some aspects, at least one of the first encoding characteristics is based on at least a first transmission parameter of the one or more transmission parameters satisfying one or more threshold values.

In some aspects, the one or more threshold values are based on a second transmission parameter of the one or more transmission parameters different from the first transmission parameter.

In some aspects, at least one of the first encoding characteristics is based on an output of a decreasing function of a first transmission parameter of the one or more transmission parameters.

In some aspects, the CB part communication component 525 may be configured to cause the UE 115 to receive, via a second set of multiple time-frequency resources, a second set of multiple CB parts associated with a second codeword, where respective CB parts of the second set of multiple CB parts corresponding to a same CB are each offset in time across the second set of multiple time-frequency resources, and where one or more first CB parts of the second set of multiple CB parts are initializing CB parts associated with third encoding characteristics that are different from the second encoding characteristics with which one or more second CB parts of the second set of multiple CB parts are associated. In some aspects, the decoding component 530 may be configured to cause the UE 115 to decode the one or more first CB parts of the second codeword according to the third encoding characteristics and the one or more second CB parts of the second codeword according to the second encoding characteristics, the third encoding characteristics are based on one or more second transmission parameters of the second codeword different from the one or more transmission parameters of the codeword.

In some aspects, a first MCS index associated with the one or more first CB parts is offset from a second MCS index associated with the one or more second CB parts by an offset value, the offset value based on the one or more transmission parameters of the codeword.

In some aspects, to support decoding the one or more first CB parts, the decoding component 530 may be configured to cause the UE 115 to decode, based on the offset value being greater than the second MCS index, the one or more first CB parts according to a lowest configured MCS index of a set of multiple MCS indices configured for the UE.

In some aspects, to support decoding the one or more first CB parts of the codeword, the decoding component 530 may be configured to cause the UE 115 to decode, based on the offset value being greater than the second MCS index, the one or more first CB parts according to a first coding rate that is less than a second coding rate associated with the lowest configured MCS index.

In some aspects, to support receiving the set of multiple CB parts, the CB part communication component 525 may be configured to cause the UE 115 to receive, based on the offset value being greater than the second MCS index, the one or more first CB parts without the one or more second CB parts.

In some aspects, to support receiving the set of multiple CB parts, the CB part communication component 525 may be configured to cause the UE 115 to receive, based on the offset value being greater than the second MCS index, data via the one or more first CB parts and one or more reference signals via the one or more second CB parts.

In some aspects, the CB part communication component 525 may be configured to cause the UE 115 to receive, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value. In some aspects, the decoding component 530 may be configured to cause the UE 115 to decode the set of multiple CB parts according to first encoding characteristics, the first encoding characteristics based on the offset value, by which the second MCS index is negatively offset, being greater than the first MCS index.

In some aspects, to support decoding the set of multiple CB parts, the decoding component 530 may be configured to cause the UE 115 to decode the one or more first CB parts according to the first MCS index and the one or more second CB parts according to a lowest configured MCS index of a set of multiple MCS indices configured for the UE.

In some aspects, to support decoding the one or more second CB parts, the decoding component 530 may be configured to cause the UE 115 to decode the one or more second CB parts according to a first coding rate that is less than a second coding rate associated with the lowest configured MCS index.

In some aspects, to support receiving the set of multiple CB parts, the CB part communication component 525 may be configured to cause the UE 115 to receive the one or more first CB parts without the one or more second CB parts.

In some aspects, to support receiving the set of multiple CB parts, the CB part communication component 525 may be configured to cause the UE 115 to receive data via the one or more first CB parts and one or more reference signals via the one or more second CB parts.

In some aspects, the CB part communication component 525 may be configured to cause the UE 115 to receive, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated. The control component 535 may be configured to cause the UE 115 to receive control signaling indicating a presence of the one or more first CB parts in the TB that are the initializing CB parts associated with the first encoding characteristics. In some aspects, the decoding component 530 may be configured to cause the UE 115 to decode, based on the control signaling, the one or more first CB parts according to the first encoding characteristics and the one or more second CB parts according to the second encoding characteristics.

In some aspects, the one or more first CB parts include control information and the one or more second CB parts include data.

In some aspects, the control signaling indicates a quantity of the one or more first CB parts present within the TB.

A processing system 520 may include or be a component of one or more chips, systems-on-chips (SoCs), chipsets, packages, components, or devices that individually or collectively constitute or include a processing system. A processing system 520 may interface with other components of a processing system 520. In one aspect, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved user experience related to reduced processing, reduced power consumption, more efficient utilization of communication resources, improved coordination between devices, longer battery life, and improved utilization of processing capability.

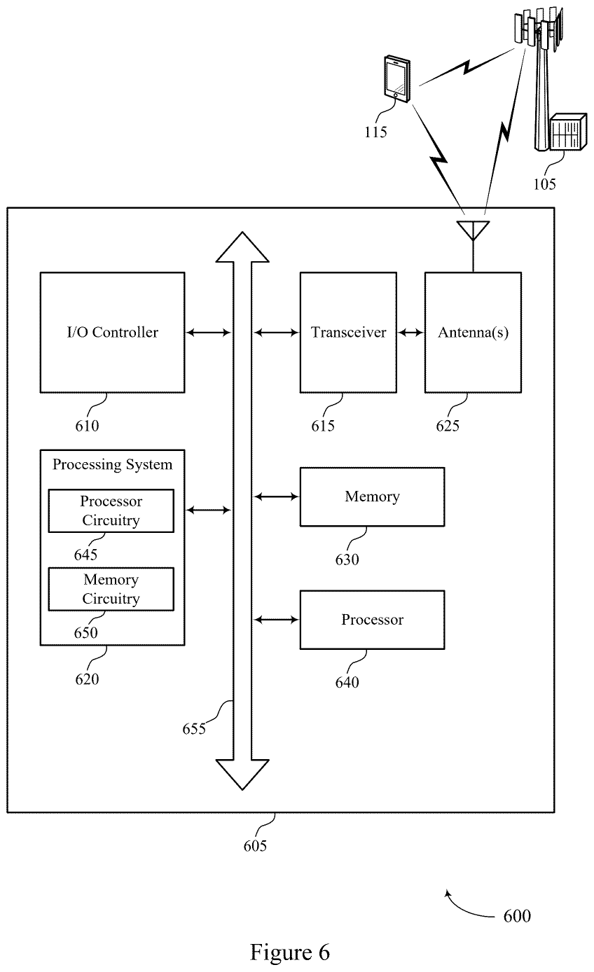

FIG. 6 shows an example of a system 600 including a device 605 that supports CB adjustments. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. In one aspect, the processing system 620 may include processor circuitry 645 and memory circuitry 650 that stores code, and may be configured to cause the device 605 to perform operations that support CB adjustments. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved user experience related to reduced processing, reduced power consumption, more efficient utilization of communication resources, improved coordination between devices, longer battery life, and improved utilization of processing capability.

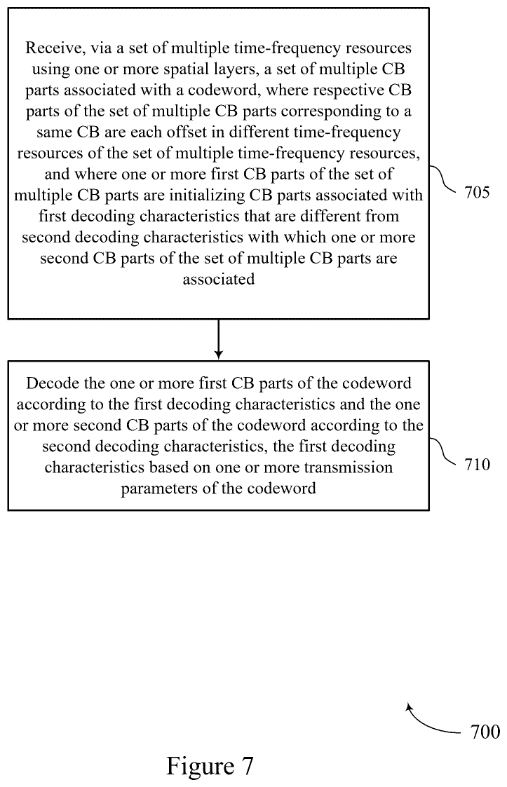

FIG. 7 shows an example of a method 700 that supports CB adjustments. Operations of the method 700 may be performed by a UE or its components (such as using a processing system configured to cause the UE 115 to perform one or more of the operations) as described herein.

At 705, the method may include receiving, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated. In some aspects, aspects of the operations of 705 may be performed by a CB part communication component 525.

At 710, the method may include decoding the one or more first CB parts of the codeword according to the first encoding characteristics and the one or more second CB parts of the codeword according to the second encoding characteristics, the first encoding characteristics based on one or more transmission parameters of the codeword. In some aspects, aspects of the operations of 710 may be performed by a decoding component 530.

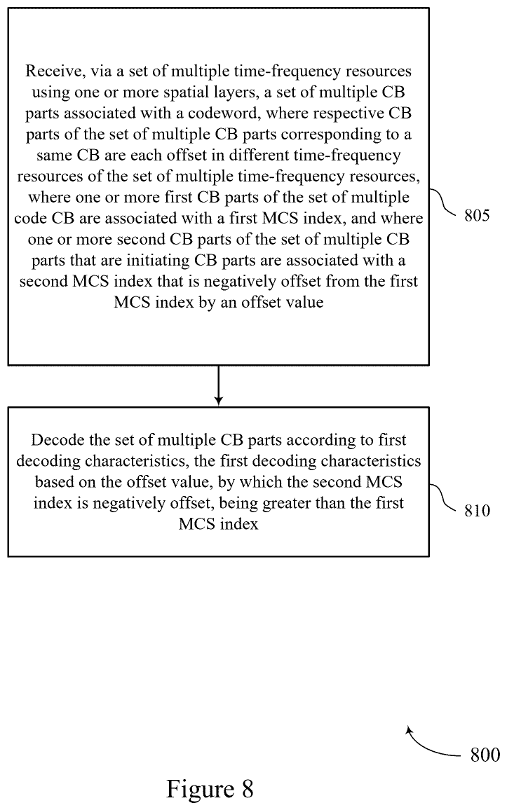

FIG. 8 shows an example of a method 800 that supports CB adjustments. Operations of the method 800 may be performed by a UE or its components (such as using a processing system configured to cause the UE 115 to perform one or more of the operations) as described herein.

At 805, the method may include receiving, via a set of multiple time-frequency resources using one or more spatial layers, a set of multiple CB parts associated with a codeword, where respective CB parts of the set of multiple CB parts corresponding to a same CB are each offset in time across the set of multiple time-frequency resources, where one or more first CB parts of the set of multiple CB parts are associated with a first MCS index, and where one or more second CB parts of the set of multiple CB parts that are initiating CB parts are associated with a second MCS index that is negatively offset from the first MCS index by an offset value. In some aspects, aspects of the operations of 805 may be performed by a CB part communication component 525.

At 810, the method may include decoding the set of multiple CB parts according to first encoding characteristics, the first encoding characteristics based on the offset value, by which the second MCS index is negatively offset, being greater than the first MCS index. In some aspects, aspects of the operations of 810 may be performed by a decoding component 530.

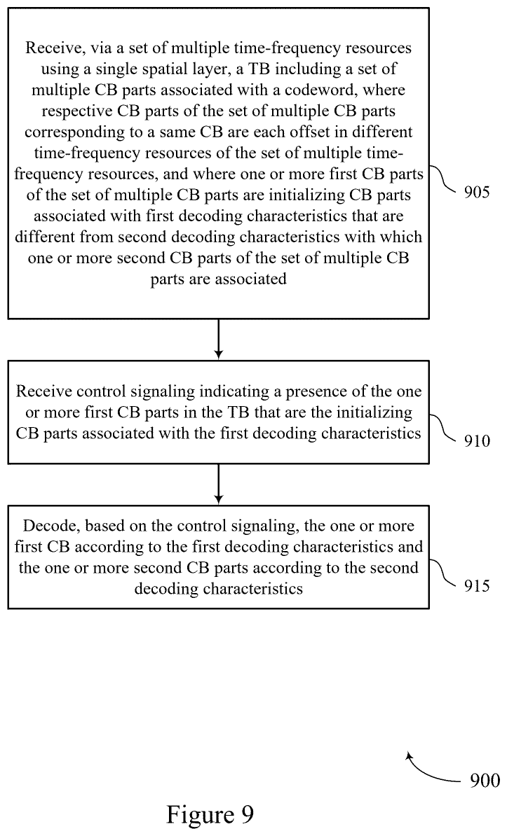

FIG. 9 shows an example of a method 900 that supports CB adjustments. Operations of the method 900 may be performed by a UE or its components (such as using a processing system configured to cause the UE 115 to perform one or more of the operations) as described herein.

At 905, the method may include receiving, via a set of multiple time-frequency resources using a single spatial layer, a TB including a set of multiple CB parts associated with a codeword, where respective CB parts of the set of multiple CB parts corresponding to a same CB are each offset in time across the set of multiple time-frequency resources, and where one or more first CB parts of the set of multiple CB parts are initializing CB parts associated with first encoding characteristics that are different from second encoding characteristics with which one or more second CB parts of the set of multiple CB parts are associated. In some aspects, aspects of the operations of 905 may be performed by a CB part communication component 525.

At 910, the method may include receiving control signaling indicating a presence of the one or more first CB parts in the TB that are the initializing CB parts associated with the first encoding characteristics. In some aspects, aspects of the operations of 910 may be performed by a control component 535.

At 915, the method may include decoding, based on the control signaling, the one or more first CB parts according to the first encoding characteristics and the one or more second CB parts according to the second encoding characteristics. In some aspects, aspects of the operations of 915 may be performed by a decoding component 530.

Implementation examples are described in the following numbered clauses:

Aspect 1: A method for wireless communications by a UE, comprising: receiving, via a plurality of time-frequency resources using one or more spatial layers, a plurality of CB parts associated with a codeword, wherein respective CB parts of the plurality of CB parts corresponding to a same CB are each offset in time across the plurality of time-frequency resources, and wherein one or more first CB parts of the plurality of CB parts are initializing CB parts associated with first encoding characteristics that are different from second encoding characteristics with which one or more second CB parts of the plurality of CB parts are associated; and decoding the one or more first CB parts of the codeword according to the first encoding characteristics and the one or more second CB parts of the codeword according to the second encoding characteristics, the first encoding characteristics based at least in part on one or more transmission parameters of the codeword.

Aspect 2: The method of aspect 1, wherein the one or more transmission parameters comprise a TB size of a TB associated with the codeword, a bandwidth of the plurality of time-frequency resources, a quantity of the one or more spatial layers, a MCS index associated with the one or more second CB parts, a quantity of CBs included in the codeword, a quantity of the plurality of time-frequency resources, or a combination thereof.

Aspect 3: The method of any of aspects 1 through 2, wherein the first encoding characteristics associated with the one or more first CB parts comprise a MCS, a shaping rate associated with probabilistic shaping of one or more bits of the one or more first CB parts, a modulation order, a coding rate, a transmit power, or a combination thereof.

Aspect 4: The method of any of aspects 1 through 3, wherein at least one of the first encoding characteristics is based at least in part on at least a first transmission parameter of the one or more transmission parameters satisfying one or more threshold values.

Aspect 5: The method of aspect 4, wherein the one or more threshold values are based at least in part on a second transmission parameter of the one or more transmission parameters different from the first transmission parameter.

Aspect 6: The method of any of aspects 1 through 5, wherein at least one of the first encoding characteristics is based at least in part on an output of a decreasing function of a first transmission parameter of the one or more transmission parameters.

Aspect 7: The method of any of aspects 1 through 6, further comprising: receiving, via a second plurality of time-frequency resources, a second plurality of CB parts associated with a second codeword, wherein respective CB parts of the second plurality of CB parts corresponding to a same CB are each offset in time across the second plurality of time-frequency resources, and wherein one or more first CB parts of the second plurality of CB parts are initializing CB parts associated with third encoding characteristics that are different from the second encoding characteristics with which one or more second CB parts of the second plurality of CB parts are associated; and decoding the one or more first CB parts of the second codeword according to the third encoding characteristics and the one or more second CB parts of the second codeword according to the second encoding characteristics, the third encoding characteristics are based at least in part on one or more second transmission parameters of the second codeword different from the one or more transmission parameters of the codeword.

Aspect 8: The method of any of aspects 1 through 7, wherein a first MCS index associated with the one or more first CB parts is offset from a second MCS index associated with the one or more second CB parts by an offset value, the offset value based at least in part on the one or more transmission parameters of the codeword.

Aspect 9: The method of aspect 8, wherein the decoding the one or more first CB parts comprises: decoding, based at least in part on the offset value being greater than the second MCS index, the one or more first CB parts according to a lowest configured MCS index of a plurality of MCS indices configured for the UE.

Aspect 10: The method of aspect 9, wherein the decoding the one or more first CB parts of the codeword comprises: decoding, based at least in part on the offset value being greater than the second MCS index, the one or more first CB parts according to a first coding rate that is less than a second coding rate associated with the lowest configured MCS index.

Aspect 11: The method of any of aspects 8 through 10, wherein the receiving the plurality of CB parts comprises: receiving, based at least in part on the offset value being greater than the second MCS index, the one or more first CB parts without the one or more second CB parts.

Aspect 12: The method of any of aspects 8 through 11, wherein the receiving the plurality of CB parts comprises: receiving, based at least in part on the offset value being greater than the second MCS index, data via the one or more first CB parts and one or more reference signals via the one or more second CB parts.

Aspect 13: A method for wireless communications by a UE, comprising: receiving, via a plurality of time-frequency resources using one or more spatial layers, a plurality of CB parts associated with a codeword, wherein respective CB parts of the plurality of CB parts corresponding to a same CB are each offset in time across the plurality of time-frequency resources, wherein one or more first CB parts of the plurality of CB parts are associated with a first MCS index, and wherein one or more second CB parts of the plurality of CB parts that are initiating CB parts are associated with a second MCS index that is negatively offset from the first MCS index by an offset value; and decoding the plurality of CB parts according to first encoding characteristics, the first encoding characteristics based at least in part on the offset value, by which the second MCS index is negatively offset, being greater than the first MCS index.

Aspect 14: The method of aspect 13, wherein the decoding the plurality of CB parts comprises: decoding the one or more first CB parts according to the first MCS index and the one or more second CB parts according to a lowest configured MCS index of a plurality of MCS indices configured for the UE.

Aspect 15: The method of aspect 14, wherein the decoding the one or more second CB parts comprises: decoding the one or more second CB parts according to a first coding rate that is less than a second coding rate associated with the lowest configured MCS index.

Aspect 16: The method of any of aspects 13 through 15, wherein the receiving the plurality of CB parts comprises: receiving the one or more first CB parts without the one or more second CB parts.

Aspect 17: The method of any of aspects 13 through 16, wherein the receiving the plurality of CB parts comprises: receiving data via the one or more first CB parts and one or more reference signals via the one or more second CB parts.

Aspect 18: A method for wireless communications by a UE, comprising: receiving, via a plurality of time-frequency resources using a single spatial layer, a TB comprising a plurality of CB parts associated with a codeword, wherein respective CB parts of the plurality of CB parts corresponding to a same CB are each offset in time across the plurality of time-frequency resources, and wherein one or more first CB parts of the plurality of CB parts are initializing CB parts associated with first encoding characteristics that are different from second encoding characteristics with which one or more second CB parts of the plurality of CB parts are associated; receiving control signaling indicating a presence of the one or more first CB parts in the TB that are the initializing CB parts associated with the first encoding characteristics; and decoding, based at least in part on the control signaling, the one or more first CB parts according to the first encoding characteristics and the one or more second CB parts according to the second encoding characteristics.

Aspect 19: The method of aspect 18, wherein the one or more first CB parts comprise control information and the one or more second CB parts comprise data.

Aspect 20: The method of any of aspects 18 through 19, wherein the control signaling indicates a quantity of the one or more first CB parts present within the TB.

Aspect 21: A UE for wireless communications, comprising a processing system that includes processor circuitry and memory circuitry that stores code, the processing system configured to cause the UE to perform a method of any of aspects 1 through 12.

Aspect 22: A UE for wireless communications, comprising at least one means for performing a method of any of aspects 1 through 12.

Aspect 23: A non-transitory computer-readable medium storing code for wireless communications, the code comprising instructions executable by one or more processors to perform a method of any of aspects 1 through 12.

Aspect 24: A UE for wireless communications, comprising a processing system that includes processor circuitry and memory circuitry that stores code, the processing system configured to cause the UE to perform a method of any of aspects 13 through 17.

Aspect 25: A UE for wireless communications, comprising at least one means for performing a method of any of aspects 13 through 17.

Aspect 26: A non-transitory computer-readable medium storing code for wireless communications, the code comprising instructions executable by one or more processors to perform a method of any of aspects 13 through 17.

Aspect 27: A UE for wireless communications, comprising a processing system that includes processor circuitry and memory circuitry that stores code, the processing system configured to cause the UE to perform a method of any of aspects 18 through 20.

Aspect 28: A UE for wireless communications, comprising at least one means for performing a method of any of aspects 18 through 20.

Aspect 29: A non-transitory computer-readable medium storing code for wireless communications, the code comprising instructions executable by one or more processors to perform a method of any of aspects 18 through 20.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. In one aspect, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other aspects, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some aspects, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some aspects, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. In one aspect, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, In one aspect, a received wireless signal. In some such examples, determining can involve a processing system performing a measurement, such as on a received signal.

As used herein, a phrase referring to “at least one of” or “one or more of” a list of items refers to any combination of those items, including single members. In one aspect, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (In one aspect, if used in conjunction with “either” or “only one of”). In one aspect, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, via a plurality of time-frequency resources using one or more spatial layers, a plurality of code block parts associated with a codeword, wherein respective code block parts of the plurality of code block parts corresponding to a same code block are each offset in time across the plurality of time-frequency resources, and wherein one or more first code block parts of the plurality of code block parts are initializing code block parts associated with first encoding characteristics that are different from second encoding characteristics with which one or more second code block parts of the plurality of code block parts are associated; and
decode the one or more first code block parts of the codeword according to the first encoding characteristics and the one or more second code block parts of the codeword according to the second encoding characteristics, the first encoding characteristics based at least in part on one or more transmission parameters of the codeword.

2. The UE of claim 1, wherein the one or more transmission parameters comprise a transport block size of a transport block associated with the codeword, a bandwidth of the plurality of time-frequency resources, a quantity of the one or more spatial layers, a modulation and coding scheme index associated with the one or more second code block parts, a quantity of code blocks included in the codeword, a quantity of the plurality of time-frequency resources, or a combination thereof.

3. The UE of claim 1, wherein the first encoding characteristics associated with the one or more first code block parts comprise a modulation and coding scheme, a shaping rate associated with probabilistic shaping of one or more bits of the one or more first code block parts, a modulation order, a coding rate, a transmit power, or a combination thereof.

4. The UE of claim 1, wherein at least one of the first encoding characteristics is based at least in part on at least a first transmission parameter of the one or more transmission parameters satisfying one or more threshold values.

5. The UE of claim 4, wherein the one or more threshold values are based at least in part on a second transmission parameter of the one or more transmission parameters different from the first transmission parameter.

6. The UE of claim 1, wherein at least one of the first encoding characteristics is based at least in part on an output of a decreasing function of a first transmission parameter of the one or more transmission parameters.

7. The UE of claim 1, wherein the processing system is further configured to cause the UE to:
receive, via a second plurality of time-frequency resources, a second plurality of code block parts associated with a second codeword, wherein respective code block parts of the second plurality of code block parts corresponding to a same code block are each offset in time across the second plurality of time-frequency resources, and wherein one or more first code block parts of the second plurality of code block parts are initializing code block parts associated with third encoding characteristics that are different from the second encoding characteristics with which one or more second code block parts of the second plurality of code block parts are associated; and
decode the one or more first code block parts of the second codeword according to the third encoding characteristics and the one or more second code block parts of the second codeword according to the second encoding characteristics, the third encoding characteristics are based at least in part on one or more second transmission parameters of the second codeword different from the one or more transmission parameters of the codeword.

8. The UE of claim 1, wherein a first modulation and coding scheme index associated with the one or more first code block parts is offset from a second modulation and coding scheme index associated with the one or more second code block parts by an offset value, the offset value based at least in part on the one or more transmission parameters of the codeword.

9. The UE of claim 8, wherein, to decode the one or more first code block parts, the processing system is configured to cause the UE to:
decode, based at least in part on the offset value being greater than the second modulation and coding scheme index, the one or more first code block parts according to a lowest configured modulation and coding scheme index of a plurality of modulation and coding scheme indices configured for the UE.

10. The UE of claim 9, wherein, to decode the one or more first code block parts of the codeword, the processing system is configured to cause the UE to:
decode, based at least in part on the offset value being greater than the second modulation and coding scheme index, the one or more first code block parts according to a first coding rate that is less than a second coding rate associated with the lowest configured modulation and coding scheme index.

11. The UE of claim 8, wherein, to receive the plurality of code block parts, the processing system is configured to cause the UE to:
receive, based at least in part on the offset value being greater than the second modulation and coding scheme index, the one or more first code block parts without the one or more second code block parts.

12. The UE of claim 8, wherein, to receive the plurality of code block parts, the processing system is configured to cause the UE to:
receive, based at least in part on the offset value being greater than the second modulation and coding scheme index, data via the one or more first code block parts and one or more reference signals via the one or more second code block parts.

13. A user equipment (UE), comprising:
a processing system that includes processor circuitry and memory circuitry that stores code, the processing system configured to cause the UE to:
receive, via a plurality of time-frequency resources using one or more spatial layers, a plurality of code block parts associated with a codeword, wherein respective code block parts of the plurality of code block parts corresponding to a same code block are each offset in time across the plurality of time-frequency resources, wherein one or more first code block parts of the plurality of code block parts are associated with a first modulation and coding scheme index, and wherein one or more second code block parts of the plurality of code block parts that are initiating code block parts are associated with a second modulation and coding scheme index that is negatively offset from the first modulation and coding scheme index by an offset value; and
decode the plurality of code block parts according to first encoding characteristics, the first encoding characteristics based at least in part on the offset value, by which the second modulation and coding scheme index is negatively offset, being greater than the first modulation and coding scheme index.

14. The UE of claim 13, wherein, to decode the plurality of code block parts, the processing system is configured to cause the UE to:
decode the one or more first code block parts according to the first modulation and coding scheme index and the one or more second code block parts according to a lowest configured modulation and coding scheme index of a plurality of modulation and coding scheme indices configured for the UE.

15. The UE of claim 14, wherein, to decode the one or more second code block parts, the processing system is configured to cause the UE to:
decode the one or more second code block parts according to a first coding rate that is less than a second coding rate associated with the lowest configured modulation and coding scheme index.

16. The UE of claim 13, wherein, to receive the plurality of code block parts, the processing system is configured to cause the UE to:
receive the one or more first code block parts without the one or more second code block parts.

17. The UE of claim 13, wherein, to receive the plurality of code block parts, the processing system is configured to cause the UE to:
receive data via the one or more first code block parts and one or more reference signals via the one or more second code block parts.

18. A user equipment (UE), comprising:
a processing system that includes processor circuitry and memory circuitry that stores code, the processing system configured to cause the UE to:
receive, via a plurality of time-frequency resources using a single spatial layer, a transport block comprising a plurality of code block parts associated with a codeword, wherein respective code block parts of the plurality of code block parts corresponding to a same code block are each offset in time across the plurality of time-frequency resources, and wherein one or more first code block parts of the plurality of code block parts are initializing code block parts associated with first encoding characteristics that are different from second encoding characteristics with which one or more second code block parts of the plurality of code block parts are associated;
receive control signaling indicating a presence of the one or more first code block parts in the transport block that are the initializing code block parts associated with the first encoding characteristics; and
decode, based at least in part on the control signaling, the one or more first code block parts according to the first encoding characteristics and the one or more second code block parts according to the second encoding characteristics.

19. The UE of claim 18, wherein the one or more first code block parts comprise control information and the one or more second code block parts comprise data.

20. The UE of claim 18, wherein the control signaling indicates a quantity of the one or more first code block parts present within the transport block.
